(19) United States
(12) Patent Application Publication
(10) Pub. No.: US 2004/0057183 A1
(43) Pub. Date: Mar. 25, 2004

(54) Fast current control of inductive loads

(76) Inventors: Kenneth Vincent, Alcester (GB); Peter J. Knight, Birmingham (GB)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/418,960

(22) Filed: Apr. 18, 2003

Related U.S. Application Data
(63) Continuation of application No. PCT/GB01/04640, filed on Oct. 17, 2001.

(30) Foreign Application Priority Data
Oct. 21, 2000 (GB) 0025832.7

(51) Int. Cl. H02H 9/06

(52) U.S. Cl. 361/118

(57) ABSTRACT

A circuit arrangement for the fast dissipation of the stored magnetic energy in an inductive load (4) controlled by a first switch (T1), comprising a high voltage-drop energy dissipation path (D2) disposed across the first switch (T1) and a second switch (T2) by which a constant-voltage diode drop path (D1) across the load (L1) can be selectively opened.

The present invention is concerned with the fast control of current in inductive electrical loads, such as solenoids, particularly but not exclusively in automotive electronic control systems.

Inductive loads, such as solenoid coils, are typically controlled by means of a switch, such as a switching transistor, connected in series with the load across a voltage supply. In automotive applications, one side of the load (referred to as the “low side”) is normally connected to ground/chassis and the other side (referred to as the “high side”) is coupled to the non-grounded side of the voltage supply. For the purpose of monitoring/measuring the current through the load, a sensing element such as a resister is placed in series with the load and the voltage drop across this resistor is measured.

Traditional technology often used current sensing near the load driving transistor, such that current monitoring was only available when the drive was turned on. When the level of the monitored current was to be used for control of the switching transistor, this arrangement therefore had poor control.

Some known arrangements have used high side control of the load using P channel MOSFET devices, but these are relatively expensive.

As is well known, the current in an inductive load decays with time when the voltage supply is removed and special circuitry must be provided to dispose of this current. The conventional practice is to achieve this by the provision of a recirculating diode disposed in parallel with the load which turns on automatically to provide a current path back to the supply. However, the rate at which a diode disposed across the load in this manner can dissipate the recirculating current is relatively poor and the current in the load therefore falls off only slowly (see curve X in FIG. 3 of the attached drawings).

Known means for achieving faster control of the current turn-off in inductive loads have typically used two MOSFET devices per channel, which has an attendant cost.

In accordance with the present invention, fast dissipation of the stored magnetic energy in an inductive load controlled by a first switch is enabled by the provision of a high-voltage-drop energy dissipation path across said first switch and a second switch by which a constant-voltage diode drop path across the load can be selectively opened.

In one preferred embodiment, said first switch comprises a switching transistor and said high-voltage drop energy dissipation path comprises a voltage regulating diode, such as a Zener diode, in parallel with the switching path of said switching transistor.

Advantageously, the switching transistor is a field-effect transistor such as a MOSFET, and the voltage regulating diode is connected between its source and drain terminals.

In another embodiment, the switching transistor is a field-effect transistor, such as a MOSFET, and the voltage regulating diode is connected, in series with a first diode, between its drain and gate terminals.

The second switch can, for example, comprise a MOSFET in series with a second diode across the series combination of the inductive load and a current sensing element.

In some particularly advantageous embodiments, said second switch commonly controls the opening of a plurality of said constant-voltage diode drop paths across a plurality of respective inductive loads, each of which is switchable by a respective first switch across which there is disposed a respective high-voltage-drop energy dissipation path.

A number of other advantageous features can be obtained using a circuit arrangement in accordance with the present invention;

(a) Phase locked current control. A small amount of ripple is allowed on the incoming demand signal, which causes the control loop to synchronise its control oscillation to that of an incoming PWM signal. This allows the external current control loop to have software controlled phase relationships between channels.

(b) Frequency locked current control. A small amount of ripple is allowed on the incoming demand signal, which causes the control loop to synchronise its control oscillation to that of the incoming PWM signal. This allows the external current control loop to have a software controlled oscillation frequency.

(c) Phase staggered control. The phase of individual current control channels is under the control of software. By software control, the control channels can be phase staggered. This results in the energise part of the control cycles being distributed evenly through time. The total current demand of the circuit is therefore more evenly distributed. The high frequency current demands of the circuit are reduced, and the frequency is raised. The reduction in peaks and the higher overall frequency allows for easier filtering and reduced electromagnetic emissions, without any additional hardware costs.

(d) Spread spectrum control. The frequency of the current control channels is under the control of software. By software control, the control channel frequencies can be changed dynamically over time. Electromagnetic emissions from the current control circuit are composed mainly of harmonics of the control frequency. By dynamically changing the frequency of control, all resulting emissions are modulated over a wider bandwidth. This reduces the peak energy of the emissions over a set measurement bandwidth, without any additional hardware costs.

The invention is described further hereinafter, by way of example only, with reference to the accompanying drawings, in which:—

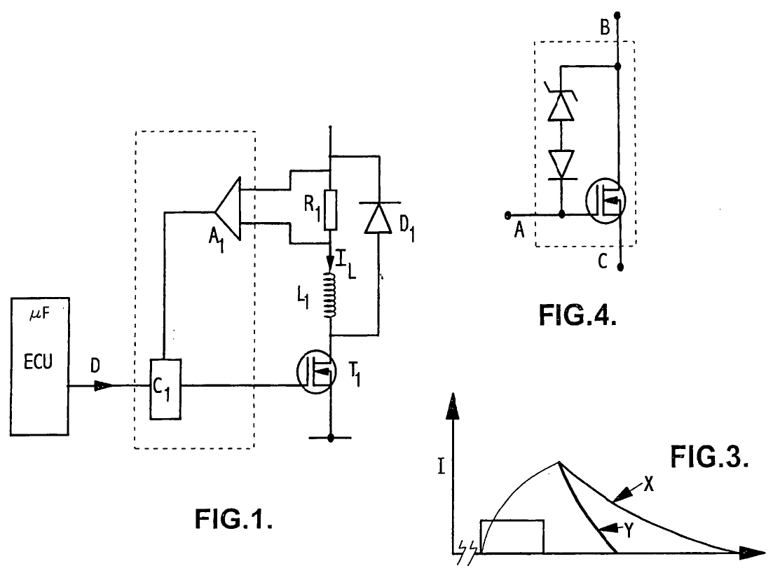

FIG. 1 is a basic circuit diagram of a known switching arrangement for controlling and monitoring the current through an inductive load;

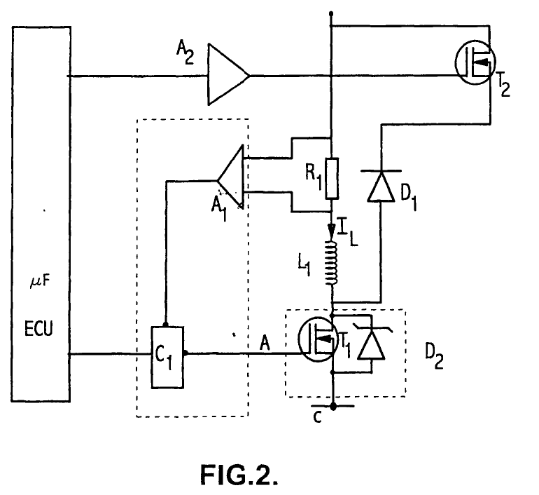

FIG. 2 is a basic circuit diagram of one embodiment of an arrangement in accordance with the present invention for controlling and monitoring the current through an inductive load;

FIG. 3 shows typical responsive curves illustrating the dissipation of recirculating current in a known system and in a system in accordance with this invention;

FIG. 4 is a circuit diagram of a possible modification to the circuit of FIG. 3;

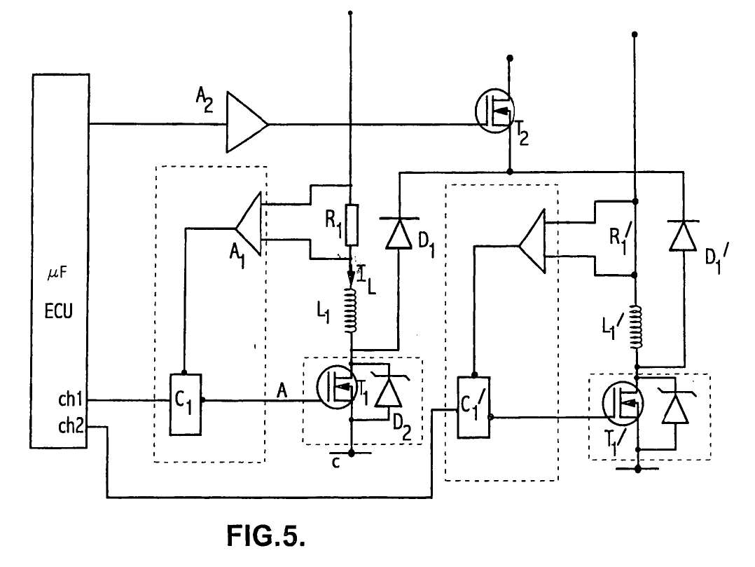

FIG. 5 is a basic circuit diagram of a multi-solenoid switching arrangement incorporating the present invention; and

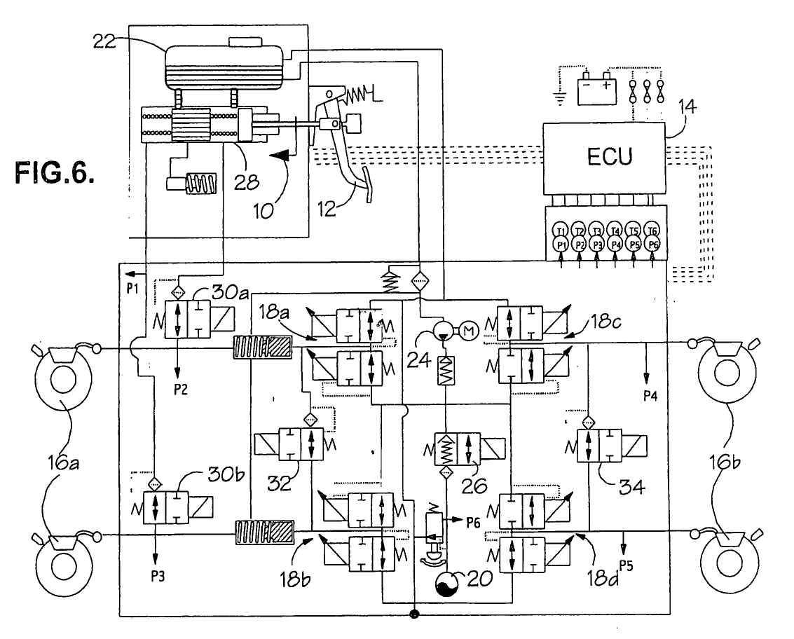

FIG. 6 shows an electro-hydraulic (EHB) braking system to which the present invention is applicable.

Referring first to FIG. 1, there is shown the basic circuit of a typical known arrangement for controlling/monitoring the current I_{L} through an inductive load L₁, such as the coil of a solenoid-operated valve. The current through the coil L₁) is switched on/off by a MOSFET T₁ driven by a controller C₁ in accordance with a demand signal D. The current I_{L} is monitored by detecting the voltage drop across a resistor R₁, disposed in series with the coil L₁, using a differential amplifier A₁ coupled back to the controller C₁ to form an analogue control loop. A recirculation diode D₁ is connected in parallel with the series connection of the resistor R₁ and load L₁. In use of this circuit arrangement, when the MOSFET T₁ is turned off, the stored energy in the coil results in a current flow which is dissipated in the voltage drop across the recirculation diode D₁. However, as mentioned hereinbefore, the rate of dissipation of this current by the diode D₁ is relatively slow and typically follows a path such as that defined by curve X in FIG. 3

Reference is now made to FIG. 2 which shows one embodiment of a circuit arrangement in connection with the present invention, wherein components having the same function are given the same reference numerals as in FIG. 1.

In this case, a MOSFET switching transistor T₂ is included in series with the recirculation diode D₁ to enable the conduction of the recirculation path through D₁ to be controlled by the ECU via a matching amplifier A₂. Thus, when the switch T₂ is closed, the diode D₁ provides a constant-voltage drop recirculation path in the normal way. However, when the switch T₂ is open-circuit, then the normal recirculation path is broken. This can be arranged to take place, for example, when it is detected via R₁ that the current I_{L} on the load L₁ is too high (above a predetermined threshold). In this case, the recirculation currents which are de-energising the load L₁ are dissipated to ground by way of a high voltage drop energy dissipator, such as a Zener diode D₂ disposed across the MOSFET T₁. This allows the stored magnetic energy in the inductive load L₁ to be dissipated from the load at a much greater rate than using the constant voltage drop diode D₁ and a curve such as that shown at Y in FIG. 3 can be obtained.

FIG. 4 shows an alternative arrangement to the Zener diode D₂ of FIG. 2 where the series combination of a Zener diode D₃ and diode D₄ is disposed across the drain-gate terminals of the MOSFET T₁. A similar characteristic curve Y can be obtained by this arrangement.

Thus, the present circuit provides a means whereby, in the event of high induced currents in the switched load, the constant-voltage-drop diode D₁ can be replaced by the high-voltage-drop Zener arrangement D₁ by opening the switch T₂.

A particular advantage of this arrangement is that the same single recirculation switch T₂ can be used for a plurality of solenoid drives at once, for example as shown in FIG. 5. FIG. 5 shows a second load L₁′, which is switchable by means of a second MOSFET T₁′, with its current being monitored by a current sensor R₁′ and coupled by an analogue control loop to its own controller C₁′ which receives an input demand from the common ECU. It will be noted that both of the recirculation diodes D₁ and D₁′ in this circuit are coupled to the supply voltage U_{b} by way of the same, single MOSFET switch T₂. This allows the advantageous arrangement of FIG. 2 to be added economically to existing load drives with one driver T₁ per channel plus just one stored switch T₂. This is possible because, from the viewpoint of channels which do not currently need the fast current decay, it does not matter if the recirculation path via T₂ is temporarily lost, for example by a 1 ms pulsed opening of T₂, to enable fast current decay via D₂ for a channel which does need it.

FIG. 6 shows a typical electrohydraulic (EHB) braking system to which the present invention is applicable. In the electrohydraulic braking system of FIG. 6, braking demand signals are generated electronically at a travel sensor 10 in response to operations of a foot pedal 12, the signals being processed in an electronic control unit (ECU) 14 for controlling the operation of brake actuators 16a, 16b at the front and back wheels respectively of a vehicle via pairs of valves 18a, 18b and 18c, 18d. The latter valves are operated in opposition to provide proportional control of actuating fluid to the brake actuators 16 from a pressurised fluid supply accumulator 20, maintained from a reservoir 22 by means of a motor-driven pump 24 via a solenoid controlled accumulator valve 26. For use, for example, in emergency conditions when the electronic control of the brake actuators is not operational for some reason, the system includes a master cylinder 28 coupled mechanically to the foot pedal 12 and by which fluid can be supplied directly to the front brake actuators 16a in a “push through” condition. In the push-through condition, a fluid connection between the front brake actuators 16a and the cylinder 28 is established by means of digitally operating, solenoid operated valves, 30a, 30b. Also included in the system are further digitally operating valves 32, 34 which respectively connect the two pairs of valves 18a, 18b, and the two pairs of valves 18c, 18d.

The system of the present invention for enabling fast switching can be applied to any of the solenoids in the arrangement of FIG. 6. Advantageously, where groups of solenoids are under the control of a single ECU such as in the case of the solenoid valves 18a-18d, 26, 32,34 and 30a, 30b in FIG. 6 (or sub-groups thereof), the arrangement of FIG. 5 can be advantageous where a single switched recirculation diode T₂ is common to all solenoids in the group or sub-group.

1. A circuit arrangement for the fast dissipation of the stored magnetic energy in an inductive load controlled by a first switch, comprising a high-voltage-drop energy dissipation path disposed across said first switch and a second switch by which a constant-voltage diode drop path across the load can be selectively opened.

2. A circuit arrangement as claimed in claim 1, wherein said first switch comprises a switching transistor and said high-voltage drop energy dissipation path comprises a voltage regulating diode in parallel with the switching path of said switching transistor.

3. A circuit arrangement as claimed in claim 2 wherein the switching transistor is a field effect transistor and the voltage regulating diode is connected between its source and drain terminals.

4. A circuit arrangement as claimed in claim 2 wherein the switching transistor is a field effect transistor and the voltage regulating diode is connected, in series with a first diode, between its drain and gate terminals.

5. A circuit arrangement as claimed in any of claims 1 to 4, wherein said second switch comprises a field effect transistor in series with a second diode across the series combination of the inductive load and a current sensing element.

6. A circuit arrangement as claimed in any of claims 1 to 5, wherein said second switch commonly controls the opening of a plurality of said constant-voltage diode drop paths across a plurality of respective inductive loads, each of which is switchable by a respective first switch across which there is disposed a respective high-voltage-drop energy dissipation path.
